(19) United States
(12) Patent Application Publication
(10) Pub. No.: US 2003/0014916 A1
(43) Pub. Date: Jan. 23, 2003

(54) Propagation tray

(76) Inventor: Douglas A. Holmberg, Lithia, FL (US)

Correspondence Address: Arthur W. Fisher, Suite 316, 5553 West Waters Avenue, Tampa, FL, 33634, US

(21) Appl. No.: 09/907,998

(22) Filed: Jul. 18, 2001

(51) Int. Cl. A01G 9/02

(52) U.S. Cl. 47/86

(57) ABSTRACT

A propagation tray configured to receive a plurality of seedlings or root cuttings comprising a tray member having a plurality of elongated propagation cells each to receive a growing media and a plurality of seedlings or root cuttings therein and a removable interior cell wall disposed between adjacent elongated propagation cells such that the selective removal of a removable interior cell wall from the tray member facilitates removal of the plurality of seedlings or root cuttings and growing media from the corresponding elongated propagation cell.

### BACKGROUNG OF THE INVENTION

1. Field of the Invention

A propagation tray comprising a tray member having a plurality of elongated propagation cells formed therein to propagate a plurality of seedlings or root cuttings therein.

2. Description of the Prior Art

Commonly, commercial nursery and farming operations entail the transplanting of millions of seedlings and rooting cuttings each year. These plants are normally started from seeds or cuttings in a controlled environment such as a hothouse and, upon reaching a desired size, the plants are transplanted for field growth or longer container growth in larger containers. Growing trays are generally used for initial growth of the plants for subsequent transplanting into a field or into larger containers for further growth.

The labor involved in providing the seedlings or rooting liners to the user represents a substantial cost factor. Thus a number of trays specifically designed for holding the individual pots have been conceived for this purpose. Unfortunately such trays are often excessively costly, labor involved in producing the liners is great, and the percentage of plants that survive is low because of configuration of the cells causing poor drainage. Also plants grown to their potential size normally become potbound and grow off poorly as a result of that condition.

Moreover removal of the seedlings for transplanting is sometimes difficult and may result in damage to the seedlings. Thus containers are made of material that is directly transplanted into the ground with the seedlings. Unfortunately, these devices do not posses rigidity necessary for easy handling without the aid of additional auxiliary support trays.

Numerous efforts have been made to provide or create a proper growing environment for seedlings and root cuttings.

U.S. Pat. No. 5,127,189 describes a propagation tray configured to receive a plurality of seedlings or the like comprising a tray member having an outer peripheral ledge formed about the periphery thereof and plurality of elongated frustum conical propagation cells each having a centrally disposed aperture formed in the upper portion in the upper portion thereof to receive individual seedlings. A drainage aperture and cell support surface are formed on the lower portion of each elongated frustum conical propagation cell such that the seedling disposed therein is provided drainage and air pruning through the drainage aperture while supported on the ground or other supporting surface by the cell support surfaces.

U.S. Pat. No. 4,658,542 is directed to a portable growing system for propagating seedlings or rooting cuttings comprising an upper propagation tray configured to receive a plurality of seedlings or rooting cuttings and a lower support bench configured to support the upper propagation tray above the ground or other supporting surface. The upper propagation tray comprises a tray member having an outer peripheral support ledge formed about the periphery thereof and plurality of propagation cells each having a centrally disposed aperture formed in the lower portion thereof to receive individual seedlings or rooting cuttings formed inwardly of the outer peripheral support ledge. The lower support bench comprises a pair of side walls held in fixed spaced relationship relative to each other by a pair of end walls and a lattice floor. The upper surfaces of the pair of the side walls and pair of end walls cooperatively forming an upper peripheral support surface to support the outer peripheral support ledge; while, the pair of side walls and the pair of end walls including a plurality of openings formed therein whereby the upper propagation tray is supported within the lower support bench such that the seedlings or rooting cuttings disposed within the plurality of propagation cells are provided drainage and air pruning through the centrally disposed apertures and through the side openings and lattice floor of the lower support bench.

U.S. Pat. No. 5,419,080 shows a tray assembly containing plants that has cells with an open top and side walls extending therefrom to a bottom floor of the cell having at least four holes, each defining an opening an opening in the floor of 0.75 to 2.25 sq. in.

U.S. Pat. No. 3,872,621 describes a horticultural cell system which comprises a belt of sheet material folded in half longitudinally along a fold line and having its two layers sealed along lines transverse to and spaced apart along the belt. The lines of seals extend from the free edges of the layers only partially across the width of the belt toward the fold line. The seals form and separate a series of cells, each suitable for receiving the root system of a mature plant, and an alternating series of web portions which space the cells a desired distance apart. The portions of the layers adjacent to the fold line form a continuous tube which is common to and communicates with each of the cells, and has a greater width than that of the cells. The root system of each of the plants can extend into the tube, which provides a common plant support system and allows the root system to expand to a greater degree than if confined solely to the individual cells.

U.S. Pat. No. 3,889,416 shows a seedling tree growing apparatus for use particularly in growing seedling reforestation trees comprises in combination a support tray and a plurality of tubes adapted to be supported vertically in the tray. The tubes are open at both ends and provided with inwardly extending longitudinal ribs which guide the roots of the seedling trees contained therein out the open, lower end of the tubes for air pruning.

U.S. Pat. No. 3,949,523 describes a structure for use in the raising of seedlings and which consists of a plurality of cells lack having an open mouth and extending downwardly from a planar or horizontal plate, preferably formed a sheet of plastic. The side walls of cell together define at least one acute angle. The side walls of each cell has an inwardly tapering shape so that they may fit one into the other when empty structures are stacked. The bottoms of the cells are permeable to water.

U.S. Pat. No. 4,173,097 relates to containers for the growth of plants including indentations in the bottom and/or side(s) of the container to increase the surface area of the part of the container in contact with the growing media from roots before encountering a media-air interface and reduce the proportion of relatively water saturated growing media in the containers.

U.S. Pat. No. 4,446,652 discloses a unitary flower pot having a water reservoir at the bottom thereof defined by a bottom wall and a soil support plate positioned above the bottom wall. The soil support plate is hinged to the pot by means of plastic resin from which the pot is formed. The soil support plate and pot are formed from the same material with the support plate at a vertical position in alignment with the axis of the pot so that it can be removed from the mold and then swung downwardly about the hinge to a horizontal position when soil is to be placed in the pot.

U.S. Pat. No. 752,370 shows a flower-pot of clay having a substantially flat bottom with a central drainage hole and a conical tapering side wall the inner face of which near the bottom has a greater taper than that of the corresponding outer face and forms a direct junction with the drainage hole by the inner and outer face intersecting with each other.

U.S. Pat. No. 3,315,410 shows a container of fibrous pulp material comprising a bottom having an upwardly and outwardly flaring side wall connected around the periphery of the bottom. The bottom includes a horizontal center portion the substantially flat plane and a conical, spaced above the corner to the portion that extends upwardly from the nter portion. A drainage aperture extends through the horizontal center portion of the bottom through the horizontal center portion of the bottom.

Additional examples of the prior art are found in U.S. Pat. No. 2,599,853; U.S. Pat. No. 3,035,369; U.S. Pat. No. 3,164,507; U.S. Pat. No. 3,386,608; U.S. Pat. No. 3,561,158; U.S. Pat. No. 3,667,159; U.S. Pat. No. 3,736,889; U.S. Pat. No. 3,868,054; U.S. Pat. No. 3,992,810; U.S. Pat. No. 4,197,674; U.S. Pat. No. 3,889,416; U.S. Pat. No. 3,931,694; U.S. Pat. No. 3,949,523; U.S. Pat. No. 4,389,814; U.S. Pat. No. 4,753,037; U.S. Pat. No. 4,962,855; U.S. Pat. No. 5,016,548; U.S. Pat. No. Des. 185,652; German No. 1,941,315; Netherlands No. 6,908,126; French 633293 and United Kingdom 1511256; United Kingdom 1,034,256; and United Kingdom 2,007,952.

Despite these efforts, there remains a need for an economical and sturdy seedling flat for handling and having the capacity of permitting the easy removal of seedlings from the flat and allowing a greater degree of air and drainage, and having a configuration not condusive to causing this potbound condition.

### SUMMARY OF THE INVENTION

The present invention relates to a propagation tray for propagating seedlings or rooting cuttings comprising a tray member configured to receive a plurality of seedlings or rooting cuttings.

The tray member comprises an outer peripheral wall having a plurality of elongated propagation cells formed therein. Each elongated propagation cell comprises an upper opening, an intermediate potting portion and a lower base or floor with apertures formed therein.

The outer peripheral wall comprises a pair of side walls held in fixed spaced relationship relative to each other by a pair of end walls. The lower base or floor extends between the lower portions of the side walls and the end walls.

Each elongated propagation cell is formed between the side walls and one end wall and removable interior cell wall disposed between adjacent elongated propagation cells or the side walls and adjacent removable interior cell walls.

Each elongated propagation cell is configured to provide the volume of the growth media together with the media support, drainage and air pruning to greatly enhance the growth rate of the seedlings or rooting cuttings and maximizes the efficient use of space within a greenhouse or other propagation area.

In use, growing media is placed or poured into each elongated propagation cell. Seedlings or cuttings are then planted in the growth media with each elongated propagation cell. Once the plants have grown to the desired size, the plants and growing media are removed from the propagation tray and transplanted into the ground or into a large container. This is accomplished by selectively removing the removable interior cell wall(s) adjacent the elongated strip of growing media and plurality of seedlings or rooting cuttings growing therein. The seedlings or rooting cuttings and supporting growing media are then individually separated for planting.

Because of the width to height ratio, an optimum volume of media is provided with an optimum degree of drainage so that the upper foliar plant growth extending from the individual propagation cells may be disposed immediately adjacent the other propagation cell without interference, while maximizing desirable root development.

The invention accordingly comprises the features of construction, combination of elements, and arrangement of parts which will be exemplified in the construction hereinafter set forth, and the scope of the invention will be indicated in the claims.

### BRIEF DESCRIPTION OF THE DRAWINGS

For a fuller understanding of the nature and object of the invention, reference should be had to the following detailed description taken in connection with the accompanying drawings in which:

FIG. 1 is a top view of the propagation tray of the present invention.

FIG. 2 is a cross-sectional end view of the propagation tray of the present invention.

FIG. 3 is a cross-sectional side view of the propagation tray of the present invention.

FIG. 4 is an exploded cross-sectional view of a plurality of the propagation trays of the present invention in a stacked configuration.

FIG. 5 is a top view of an alternate embodiment of the floor and cell wall retainer of the present invention.

FIG. 6 is a cross-sectional side view of propagation tray of the present invention with the plants rooting.

FIG. 7 is a top view of another alternate embodiment of the cell wall retainer of the present invention.

FIG. 8 is a top view of yet another alternate embodiment of the cell wall retainer of the present invention.

FIG. 9 is a top view of still yet another alternate embodiment of the floor and cell wall retainer of the present invention.

FIG. 10 is a top view of another alternate embodiment of the cell wall retainer of the present invention.

FIGS. 11A and 11B depict another alternate embodiment of the cell wall retainer of the present invention.

FIGS. 12A and 12B show yet another alternate embodiment of the cell wall retainer of the present invention.

Similar reference characters refer to similar parts throughout the several views of the drawings.

### DETAILED DESCRIPTION OF THE PREFERRED EMBODIMENT

The present invention relates to a propagation tray generally indicated as 10 for propagating a plurality of seedlings or rooting cuttings each indicated as 12 comprising a tray member generally indicated as 14 and a plurality of removable interior cell walls each indicated as 16 including an upper portion and a lower portion and opposite end portions to cooperatively form a plurality of elongated propagation cells each indicated as 18 to receive a growing media 20 for the seedlings or rooting cuttings 12.

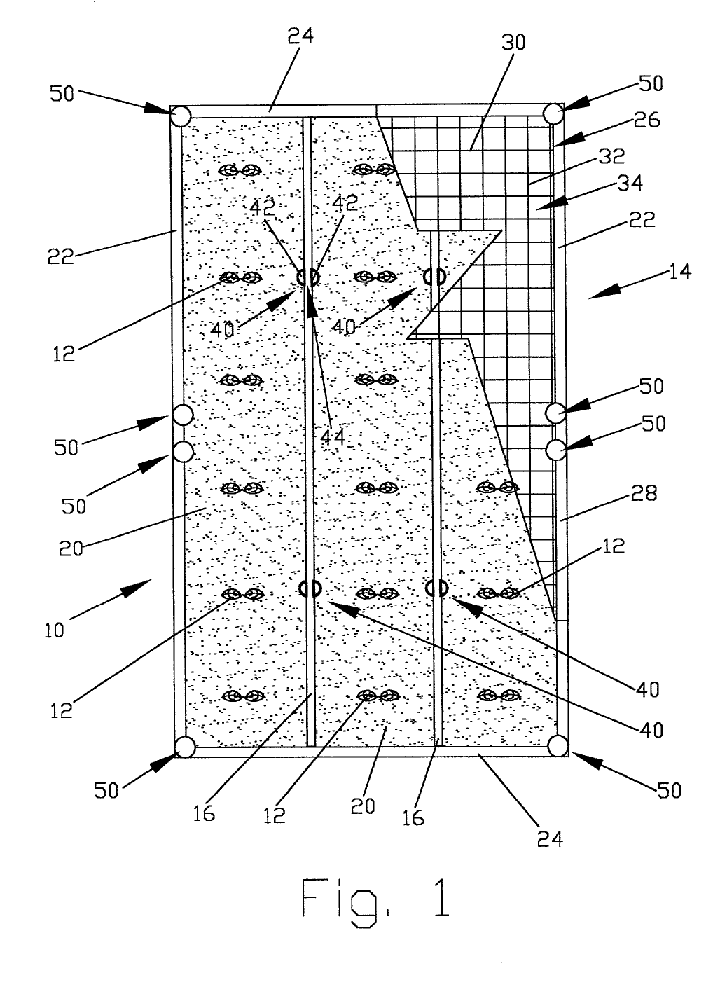

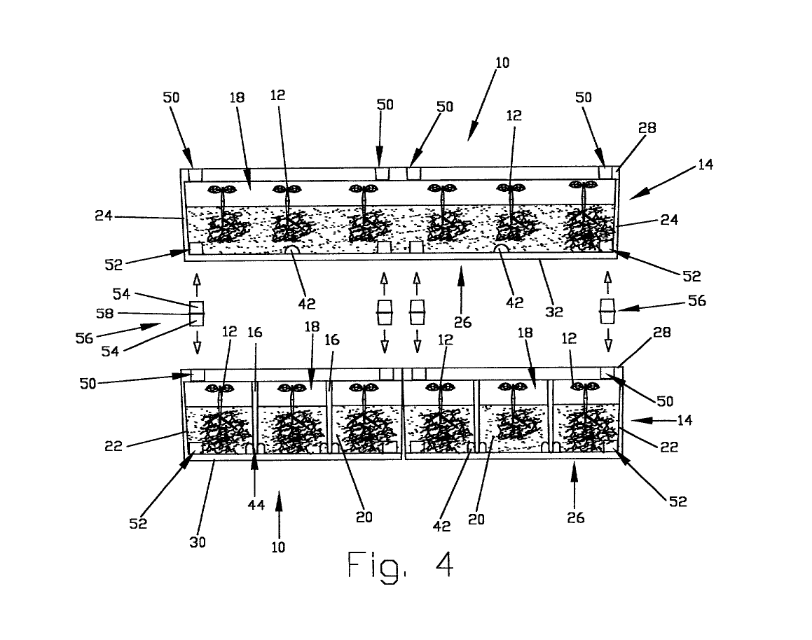

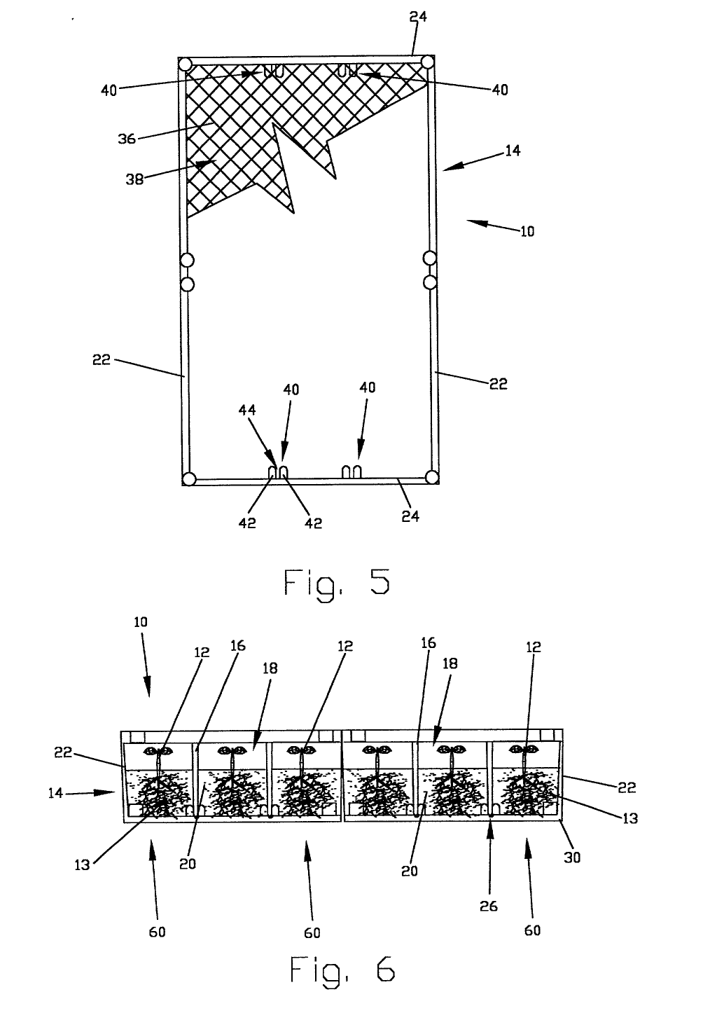

The tray member 14 comprises a pair of side walls each indicated as 22 disposed in spaced relationship relative to each other by a pair of end walls each indicated as 24 and a lower base or floor generally indicated as 26. The upper surfaces of the side walls 22 and the end walls 24 cooperatively form an upper tray support surface 28 to engage and support the lower base or floor 26 of one or more tray members 14 in a stacked array for shipping or transportation as shown in FIG. 4. The lower base or floor 26 comprises a lattice having a plurality of lateral floor members each indicated as 30 extending between the side walls 22 and a plurality of longitudinal floor members each indicated as 32 extending between the end walls 24. As shown in FIG. 1, the plurality of floor members 30 and 32 are perpendicular to form square or rectangular openings 34. Alternately, as shown in FIG. 5, the lower base or floor 26 comprises a lattice of diagonally disposed members each indicated as 36 cooperatively forming a plurality of diamond shaped openings each indicated as 38. As shown in FIGS. 1 and 5, the total area of the openings 34 and 38 is greater than the total area of the plurality of lateral floor members 30 and plurality of longitudinal floor members 32, and diagnonally disposed members 36 respectively.

The propagation tray 10 further includes a plurality of cell wall retainers to retain the removable interior cell walls 16 in position when in the tray member 14 to form the elongated propagation cells 18 to receive and support the growing media 20 and plants 12 therein.

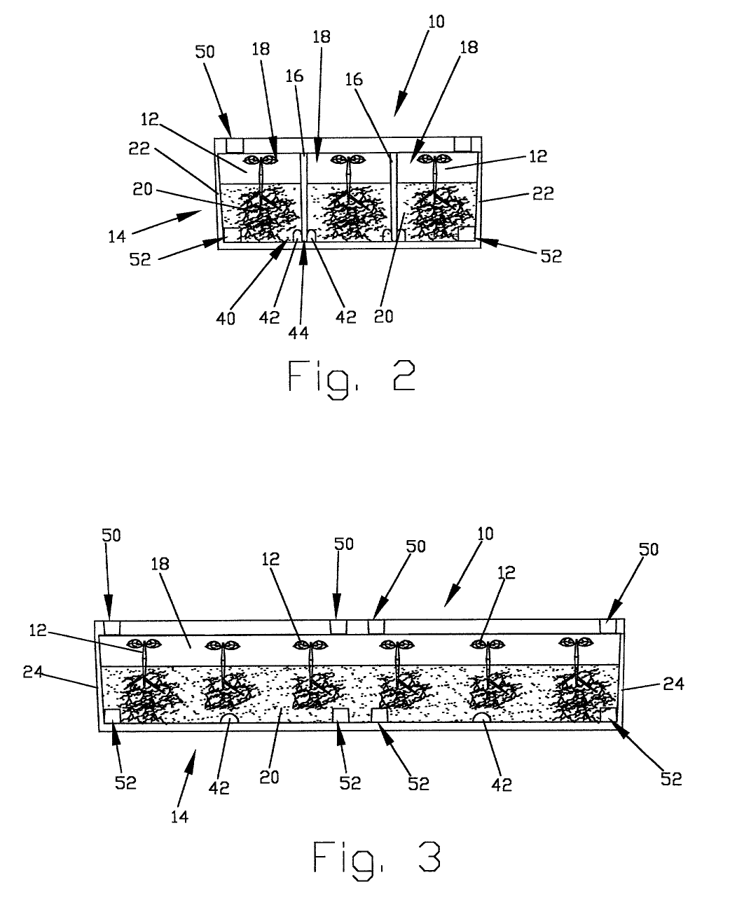

As shown in FIGS. 1 through 4, each cell wall retainer generally indicated as 40 comprises a pair of retainer members or posts each indicated as 42 extending upwardly from the lower base or floor 26 to cooperatively form a retainer space or opening 44 therebetween to removably receive the lower portion or edge of a corresponding removable interior cell wall 16 therein. As depicted, each removable interior cell wall 16 is held in place by a pair of cell wall retainers 40 disposed in spaced relationship relative to each other. Each elongated propagation cell 18 is configured to provide the volume of the media together with the media support, drainage and air pruning to enhance the growth rate of the seedlings or rooting cuttings 12 and maximize the efficient use of space within the greenhouse or other growing area.

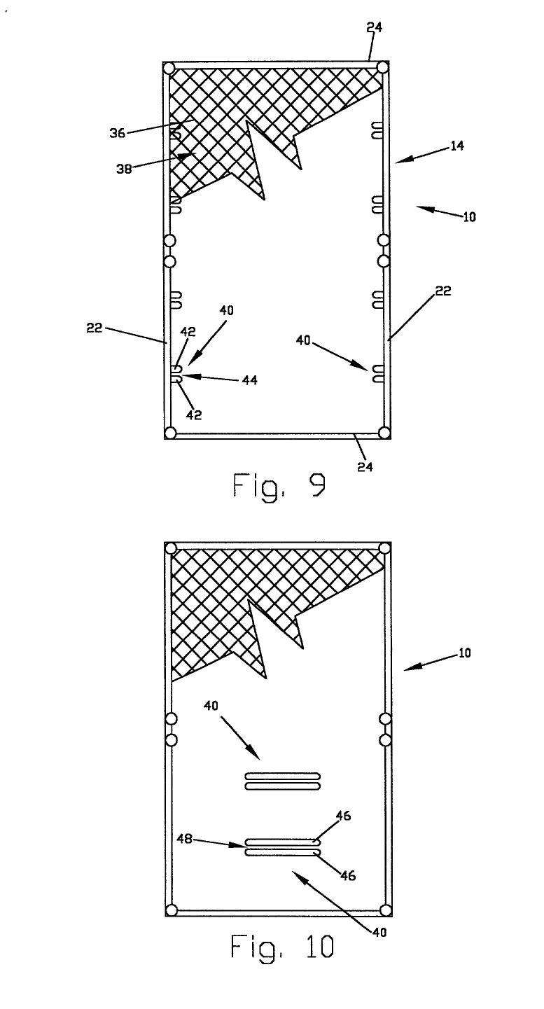

FIGS. 5 and 9 show alternate embodiments of the cell wall retainers 40. Each cell wall retainer 40 comprises a pair of retainer members or posts 42 extending inwardly from the end walls 24 and side walls 22 respectively to cooperatively form a retainer space or opening 44 therebetween to removably receive one end portion of the corresponding removable interior cell wall 16 therein.

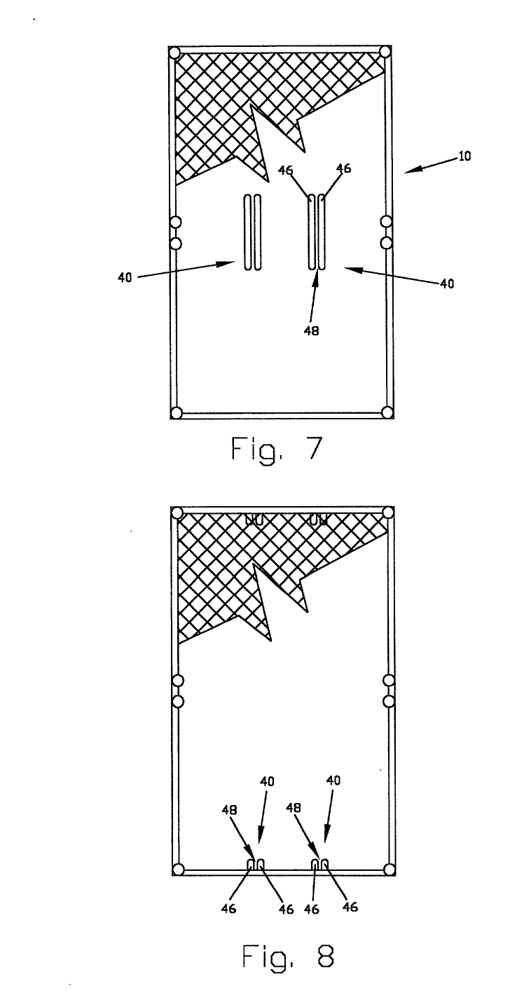

FIGS. 7 and 10 show another alternate embodiment of the cell wall retainers 40 comprising a pair of elongated retainer members each indicated as 46 extending upwardly from the lower base of floor 26 to cooperatively from an elongated retainer groove 48 therebetween to removably receive the lower portion a corresponding removably interior cell wall 16 therein.

FIG. 8 shows yet another alternate embodiment of the cell wall retainers 40 comprising a pair of elongated retainer members each indicated as 46 extending outwardly from each end wall 26 to cooperatively form an elongated retainer groove 48 therebetween to removably receive opposite end portions a corresponding removable interior cell wall 16 therein.

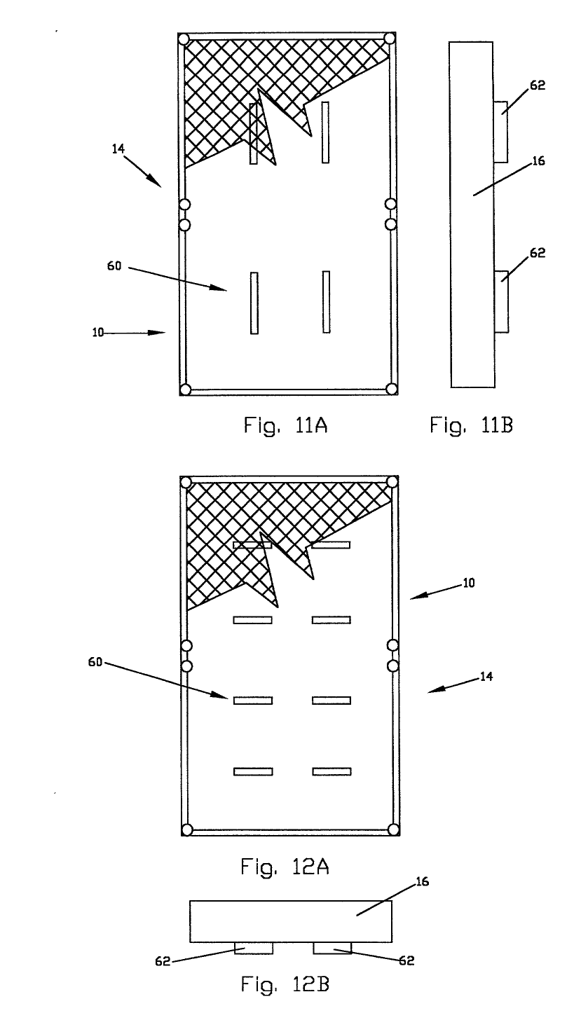

FIGS. 11A and 11B and FIGS. 12A and 12B show still another embodiment of cell wall retainer comprising at least one opening of recess 60 found in the lower base or floor 26 to receive a corresponding tab or member 62 formed on the removable interior cell wall 16.

A pair of openings or recesses 60 may be formed on the length FIG. 11A, or the width FIG. 12A, to receive a corresponding pair of tabs or members 62, FIGS. 11B and 12B.

As best shown in FIG. 4, the propagation tray 10 may further include structure to facilitate stacking for temporary storage, movement or and transportation. Specifically, a plurality of tapered upper stacking apertures or recesses each indicated as 50 are formed on the upper portion of the tray member 14 and a corresponding plurality of tapered lower stacking apertures or recesses each indicated as 52 are formed on the lower portion of the tray member 14 to selectively receive opposite tapered end portions 54 of a corresponding stacking post generally indicated as 56. A limit or stop 58 is formed on the mid-portion of each stacking post 56 to limit movement of the tapered end portions 54 into the tapered upper stacking apertures or recesses 50 and tapered lower stacking apertures or recesses 52. As best shown in FIGS. 1 and 4, the tapered upper stacking apertures or recesses 50 and tapered lower stacking apertures or recesses 52 may be formed at or near the corners of the tray member 14 and the mid-portion of each end side wall 22 of the tray member 14 such that the propagation trays 10 can be alternately stacked length to width to length to enhance the stability of the stack of propagation trays 10 during movement and shipping.

In use, the growing media 20 is placed or poured into each elongated propagation cell 18. Then seedlings or root cuttings 12 are planted in the growth media 20 within each elongated propagation cell 18. Once the plants 12 have grown to the desired size, the removable interior cell wall(s) 16 is/are removed. This allows the plants 12 and corresponding strip of growing media 20 to be removed from the corresponding elongated propagation cell 18 and transplanted.

It will thus be seen that the objects set forth above, among those made apparent from the preceding description are efficiently attained and since certain changes may be made in the above construction without departing from the scope of the invention, it is intended that all matter contained in the above description or shown in the accompanying drawing shall be interpreted as illustrative and not in a limiting sense.

It is also to be understood that the following claims are intended to cover all of the generic and specific features of the invention herein described, and all statements of the scope of the invention which, as a matter of language, might be said to fall therebetween.

Now that the invention has been described,

What is claimed is:

1. A propagation tray to receive a plurality of seedlings or root cuttings comprising a tray member including a pair of side walls, a pair of end walls and a floor having a plurality of apertures formed therethrough having a plurality of elongated propagation cells each to receive a growing media and a plurality of seedlings or root cuttings therein and a removable interior cell wall disposed between adjacent elongated propagation cells such that the selective removal of a removable interior cell wall from said tray member facilitates removal of the plurality of seedlings or root cuttings and growing media from the corresponding elongated propagation cell.

2. The propagation tray of claim 1 further including at least one cell wall retainer to retain said removable interior cell wall in position when in said tray member.

3. The propagation tray of claim 2 wherein said floor comprises a lattice including a plurality of intersecting floor members.

4. The propagation tray of claim 3 wherein the area of said apertures is greater than the area of said plurality of intersecting floor members.

5. The propagation tray of claim 1 further including at least one cell wall retainer comprising a pair of retainer members extending upwardly from said floor to cooperatively form a retainer space therebetween to removably receive a portion of a removable interior cell wall.

6. The propagation tray of claim 5 wherein said floor comprises a lattice including a plurality of intersecting floor members.

7. The propagation tray of claim 6 wherein the area of said apertures is greater than the area of said plurality of intersecting floor members.

8. The propagation tray of claim 1 further including a pair of cell wall retainers disposed in spaced relationship relative to each other, each said cell wall retainer comprising a pair of retainer members extending upwardly from said floor to cooperatively form a retainer space therebetween to removably receive a portion of a removable interior cell wall.

9. The propagation tray of claim 8 wherein said floor comprises a lattice including a plurality of intersecting floor members.

10. The propagation tray of claim 9 wherein the area of said apertures is greater than the area of said plurality of intersecting floor members.

11. The propagation tray of claim 1 further including at least one cell wall retainer comprising a pair of retainer members extending outwardly from each said end wall to cooperatively form a retainer space therebetween to removably receive a portion of a removable interior cell wall.

12. The propagation tray of claim 11 wherein said floor comprises a lattice including a plurality of intersecting floor members.

13. The propagation tray of claim 12 wherein the area of said apertures is greater than the area of said plurality of intersecting floor members.

14. The propagation tray of claim 1 further including a pair of cell wall retainers disposed in spaced relationship relative to each other, each said cell wall retainer comprising a pair of retainer members extending outwardly from each said end wall to cooperatively form a retainer space therebetween to removably receive a portion of a removable interior cell wall.

15. The propagation tray of claim 14 wherein said floor comprises a lattice including a plurality of intersecting floor members.

16. The propagation tray of claim 15 wherein the area of said apertures is greater than the area of said plurality of intersecting floor members.

17. The propagation tray of claim 1 further including at least one cell wall retainer comprising a pair of elongated retainer members extending upwardly from said floor to cooperatively form an elongated retainer groove therebetween to removably receive a portion of a removable interior cell wall.

18. The propagation tray of claim 17 wherein said floor comprises a lattice including a plurality of intersecting floor members.

19. The propagation tray of claim 18 wherein the area of said apertures is greater than the area of said plurality of intersecting floor members.

20. The propagation tray of claim 1 further including at least one cell wall retainer comprising a pair of elongated retainer members extending outwardly from each said end wall to cooperatively form an elongated retainer groove therebetween to removably receive a portion of a removable interior cell wall.

21. The propagation tray of claim 20 wherein said floor comprises a lattice including a plurality of intersecting floor members.

22. The propagation tray of claim 21 wherein the area of said apertures is greater than the area of said plurality of intersecting floor members.

23. The propagation tray of claim 1 further including stacking structure to facilitate stacking for temporary storage, movement and transportation.

24. The propagation tray of claim 23 wherein said stacking structure comprises a plurality of upper stacking apertures formed on the upper portion of said tray member and a plurality of lower stacking apertures formed on the lower portion of said tray member to selectively receive opposite end portions of a corresponding stacking post.

25. The propagation tray of claim 24 wherein each said stacking post includes a stop formed thereon to limit movement of said end portions into said upper stacking apertures and said lower stacking apertures.

26. The propagation tray of claim 25 wherein said stacking apertures are tapered and said opposite end portions of said stacking posts are tapered.

27. The propagation tray of claim 24 wherein said upper stacking apertures and said lower stacking apertures are formed near the corners of said tray member and the mid-portion of each said side wall.

28. The propagation tray of claim 23 wherein said stacking structure comprises a plurality of upper stacking recesses formed on the upper portion of said tray member and a plurality of lower stacking recesses formed on the lower portion of said tray member to selectively receive opposite end portions of a corresponding stacking post.

29. The propagation tray of claim 28 wherein each said stacking post includes a stop formed thereon to limit movement of said end portions into said upper stacking recesses and said lower stacking recesses.

30. The propagation tray of claim 29 wherein said stacking recesses are tapered and said opposite end portions of said stacking posts are tapered.

31. The propagation tray of claim 30 wherein said upper stacking recesses and lower stacking recesses are formed near the corners of said tray member and the mid-portion of each said side wall.

32. The propagation tray of claim 1 further including at least one cell wall retainer comprising a pair of retainer members extending outwardly from each said side wall to cooperatively form a retainer space therebetween to removably receive a portion of a removable interior cell wall.

33. The propagation tray of claim 32 wherein said floor comprises a lattice including a plurality of intersecting floor members.

34. The propagation tray of claim 33 wherein the area of said apertures is greater than the area of said plurality of intersecting floor members.

35. The propagation tray of claim 1 further including a pair of cell wall retainers disposed in spaced relationship relative to each other, each said cell wall retainer comprising a pair of retainer members extending outwardly from each said side wall to cooperatively form a retainer space therebetween to removably receive a portion of a removable interior cell wall.

36. The propagation tray of claim 35 wherein said floor comprises a lattice including a plurality of intersecting floor members.

37. The propagation tray of claim 36 wherein the area of said apertures is greater than the area of said plurality of intersecting floor members.

38. The propagation tray of claim 1 further including at least one cell wall retainer comprising at least one opening formed in said floor to removably receive a tab formed on said removable interior cell wall.

39. The propagation tray of claim 38 wherein said floor comprises a lattice including a plurality of intersecting floor members.

40. The propagation tray of claim 39 wherein the area of said apertures is greater than the area of said plurality of intersecting floor members.

41. The propagation tray of claim 1 further including at least one cell wall retainer comprising a pair of of openings formed in said floor to removably receive corresponding tab formed on said removable interior cell wall.

42. The propagation tray of claim 41 wherein said floor comprises a lattice including a plurality of intersecting floor members.

43. The propagation tray of claim 42 wherein the area of said apertures is greater than the area of said plurality of intersecting floor members.
